(19) United States
(12) Patent Application Publication
(10) Pub. No.: US 2006/0066824 A1
(43) Pub. Date: Mar. 30, 2006

(54) Method and system for contamination detection and monitoring a lithographic exposure tool and operating method for the same under controlled atmospheric conditions

(76) Inventors: Uwe Knappe, Niemtsch (DE); Uzodinma Okoroanyanwu, Clifton Park, NY (US)

Correspondence Address: WILLIAMS, MORGAN & AMERSON, 10333 RICHMOND, SUITE 1100, HOUSTON, TX, 77042, US

(21) Appl. No.: 11/135,721

(22) Filed: May 24, 2005

(30) Foreign Application Priority Data
Sep. 30, 2004 (DE) 10 2004 047 677.2

(51) Int. Cl. G03B 27/52

(52) U.S. Cl. 355/30; 356/237.2

(57) ABSTRACT

By using highly efficient detection techniques, such as chromatography and absorption spectroscopy, one or more contaminants may be identified and the concentration thereof may quantitatively be determined. In this way, the adverse effect on critical components of exposure tools, such as reticles and lenses in the form of, for instance, deposited inorganic salts, may significantly be reduced and the process performance may be enhanced.

### BACKGROUND OF THE INVENTION

1. Field of the Invention

The present invention relates to the field of fabrication of integrated circuits, and, more particularly, to the photolithographic formation of semiconductor related features on a substrate.

2. Description of the Related Art

Fabrication of integrated circuits requires the precise formation of features having dimensions as small as 50 nm and even less in sophisticated devices, wherein a very small tolerance for errors is required. Such features may be formed in a material layer formed above an appropriate substrate, such as a semiconductor substrate, a metal-coated substrate and the like. These features of precisely controlled size are generated by patterning the material layer by performing photolithography processes frequently in combination with etch processes. For instance, during the formation of circuit elements of an integrated circuit on and in a specific material layer, a masking layer may be formed over the material layer to be patterned to define these features in the material layer while using the masking layer as an etch mask during a substantially anisotropic etch process. Generally, a masking layer may consist of or may be formed by means of a layer of photoresist that is patterned by a lithographic process. During the lithographic process, the resist may be spin-coated onto the substrate surface and is then selectively exposed to ultraviolet radiation. After developing the photoresist, depending on the type of resist, positive resist or negative resist, the exposed portions or the non-exposed portions are removed to form the required pattern in the layer of photoresist.

In other lithographic processes involved in the fabrication of integrated circuits, short wavelength radiation sources, such as ion, electron and X-ray sources, may be used to modify a masking layer, which may then be patterned by a corresponding etch process, or the beam of radiation that is precisely scanned across the surface may directly remove the material of the masking layer. In this way, for instance, reticles may be fabricated to form a patterned metal layer on a quartz substrate. This reticle may then be used as an exposure mask for imaging the reticle pattern into a photoresist layer formed on a semiconductor substrate.

Since the dimensions of the patterns in sophisticated integrated circuits are steadily decreasing, the equipment used for patterning device features have to meet very stringent requirements with regard to resolution and overlay accuracy of the involved fabrication processes. In this respect, resolution is considered as a measure specifying the consistent ability to print images of a minimum size under conditions of predefined manufacturing variations. One important factor in improving the resolution is represented by the lithographic process, in which patterns contained in the photo mask or reticle are optically transferred to the layer of photoresist via an optical imaging system. Therefore, great efforts are made to steadily improve optical properties of the lithographic system, such as numerical aperture, depth of focus and wavelength of the light source used. The quality of the lithographic imagery is extremely important in creating very small feature sizes.

Of comparable importance, however, is the accuracy with which an image can be positioned on the surface of the substrate. Integrated circuits are typically fabricated by sequentially patterning material layers, wherein features on successive material layers bear a spatial relationship to one another. Each pattern formed in a subsequent material layer has to be aligned to a corresponding pattern formed in the previously patterned material layer within specified registration tolerances.

These registration tolerances are caused by, for example, a variation of a photoresist image on the substrate due to non-uniformities in such parameters as resist thickness, baking temperature, exposure and development. Furthermore, non-uniformities of the etching processes can also lead to variations of the etched features. In addition, there exists an uncertainty in overlaying the image of the pattern for the current material layer to the pattern of the previously formed material layer while photolithographically transferring the image onto the substrate.

A further aspect affecting the quality of device features and hence the electrical behavior thereof is the employment of substrates, i.e., wafers, having an increased diameter, wherein a typical wafer diameter is currently 200 mm with the prospect of 300 mm to become the standard wafer diameter in modern semiconductor facilities. Large diameters, although desirable in view of economical considerations, may, however, exacerbate the problem of non-uniformities across the wafer surface, especially as the minimum device dimensions, also referred to as critical dimensions (CD), steadily decrease. It is therefore desirable to minimize features variations not only from wafer to wafer but also across the entire wafer surface to allow semiconductor manufacturers to use processes the tolerances of which may be set more tightly to achieve improved production yield while at the same time enhance device performance in view of, for example, operational speed. Otherwise, the fluctuations across the wafer (and the wafer-to-wafer variations) may have to be taken account of, thereby requiring a circuit design that tolerates higher process discrepancies, which usually results in reduced device performance.

Despite the enormous efforts that are currently being made in order to further enhance the capabilities of wafer steppers and step and scan lithography devices for imaging circuit features from the reticle to the resist layer by projection lithography, recently an increasing number of experimental results report on contamination defects of 248, 193, 157 and 13.4 nm reticles and optical elements of exposure tools. These contaminations may include inorganic salts and condensable organic materials. Especially, the inorganic salts cause haze effects, which are referred to as progressive defects, since the defect rate increases over the course of production usage of reticle and lens elements, even if the reticles have been determined to be clean prior to the usage for semiconductor production. Although investigations have shown that these progressive defects may be observable at almost all lithographic wavelengths, this contamination problem is especially severe in the 193 nm lithography, particularly in combination with the processing of 300 mm wafers, which may become the standard substrate size of modern integrated circuit facilities. The contaminations of optical surfaces are typically inhomogeneous in their composition and may usually exhibit a difference in refractive index compared to the optical elements, thereby causing light scattering and thus resulting in non-uniformities of the radiation flux incident on the wafer plane. Moreover, in extreme cases, the contamination may render the optical elements unusable after a certain period of operation at reduced reliability, which finally requires the replacement of these optical elements. Moreover, the contamination may cause significant variation during the imaging of critical circuit elements, such as gate electrodes of field effect transistors, thereby significantly affecting production yield and device performance.

In view of the situation outlined above, a need exists for a technique that solves, or at least reduces the effects of, one or more problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present invention is directed to a system and a method for imaging features onto a substrate surface by lithography, especially by short wavelength lithography, in that the environmental conditions, that is, the surrounding atmosphere, of the optical elements and the substrate are taken into consideration during the lithographic process. Trace contaminations in the form of water, oxygen, carbon monoxide, carbon dioxide, volatile and condensable organic compounds, inorganic acidic gases, such as sulphur dioxide and nitrogen oxides, as well as silicon oxide compounds, such as silicones and siloxanes, may not only attenuate the exposure radiation but may also interact with the exposure radiation to form stable contamination layers on optical surfaces. According to the present invention, by taking into consideration the presence of any contamination and assessing the same as one further “tool parameter” to be accounted and monitored for during operation of an exposure tool, the adverse effects of contamination layers deposited on reticles, optical elements and the like, as well as the effects of light absorption and scattering by volatile molecular contaminants may be reduced.

According to one illustrative embodiment of the present invention, an exposure system comprises a radiation source configured to provide a radiation of a specified wavelength range and exposure dose range. The system further comprises an exposure chamber having a chamber atmosphere and an optical system that is disposed in the exposure chamber and configured to receive radiation from the radiation source and image the received radiation onto a substrate. Furthermore, the system comprises a detection system configured to quantitatively detect at least one contaminant in the chamber atmosphere.

According to yet another illustrative embodiment of the present invention, a method comprises operating an exposure tool comprising a radiation source, an exposure chamber and an optical system disposed within the exposure chamber. The method further comprises monitoring an atmosphere within the exposure chamber to provide a quantitative indication for at least one contaminant in the atmosphere. Finally, an operational status of the exposure tool is estimated on the basis of the quantitative indication.

According to still another illustrative embodiment of the present invention, a method comprises operating, during a first operating period, an exposure tool comprising a radiation source, an exposure chamber and an optical system disposed within the exposure chamber. The method further comprises monitoring an atmosphere within the exposure chamber to provide an quantitative indication for at least one contaminant in the atmosphere. An operational mode is then established for the exposure tool for a second operating period on the basis of the quantitative indication and the exposure tool is operated in the operational mode during the second operating period.

In yet a further illustrative embodiment of the present invention, a method comprises operating an exposure tool comprising a radiation source, an exposure chamber and an optical system disposed within the exposure chamber, wherein operating the exposure tool comprises transferring an image onto one or more first substrates. The method further comprises determining a quantitative indication of at least one characteristic of the images formed on the one or more first substrates. Additionally, a condition of a component of the exposure tool is determined, which is exposed to an atmosphere within the exposure chamber and a threshold of the quantitative indication is then determined on the basis of the quantitative indication and the condition, wherein the threshold represents an invalid tool status. The method further comprises operating the exposure tool to process one or more second substrates to form the image on the one or more second substrates and determining the quantitative indication for the one or more second substrates. Finally, the quantitative indication for the one or more second substrates is compared with the threshold to estimate whether a current tool status is an invalid tool status.

### BRIEF DESCRIPTION OF THE DRAWINGS

The invention may be understood by reference to the following description taken in conjunction with the accompanying drawings, in which like reference numerals identify like elements, and in which:

FIGS. 1a-1c schematically show sketches of an exposure system in accordance with illustrative embodiments of the present invention, wherein an atmosphere is monitored in view of volatile and/or deposited trace contaminants.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As previously explained, the present invention is based on the concept that, for sophisticated exposure tools, not only tool parameters, such as the status of a radiation source, the status of an optical system, the status of a reticle or photo mask, and the like, but also the environment or atmosphere within an exposure chamber may be considered as an important tool parameter, which may significantly affect the performance of the exposure tool, in particular when extremely short wavelength radiation is used for imaging a pattern onto a substrate plane. Hence, exposure systems in accordance with the present invention using ultraviolet radiation, x-rays, electron beams, and the like may be equipped at least temporarily by an appropriate detection and/or monitoring system that enables the detection of one or more trace contaminations which may be introduced into the exposure system from a variety of sources, such as the outgassing of materials of the exposure system, and/or the reticle, and/or the substrate to be processed, purge gases, defective filters, and the like. Moreover, certain contaminants may be produced by the interaction of the short wavelength radiation with gaseous components within the atmosphere of the exposure system thereby generating highly reactive oxidants, such as ozone, OH— radicals and hydrogen peroxide, and the like, which may react with other components and contaminants to form compounds that may even be deposited on sensitive surfaces, such as reticle surfaces, optical surfaces of lenses, mirrors, and the like. With respect to the deposition of inorganic salts on reticles and optical components of exposure tools operating at 193 nm, Raman spectroscopic compositional analyses have revealed that mostly ammonium sulphate ((NH₄)₂SO₄) is deposited on sensitive component surfaces, thereby significantly degrading the tool performance in the form of a progressive defect rate. Without restricting the present invention to the following explanation regarding the reaction path, it is presently believed that physical and chemical processes in the exposure chamber of deep-UV steppers and scanners are responsible for the formation of inorganic salts from precursor gases SO₂, NOₓ, which may typically be present in minute amounts within the atmosphere of the exposure chamber. These precursor gases may be oxidized within the exposure atmosphere to sulphuric acid (H₂SO₄) and nitric acid (HNO₃) by oxidants such as ozone, hydrogen peroxide, hydroxides, which are generated from oxygen and water by the interaction of the exposure radiation with the ambient atmosphere within the exposure chamber. Once formed, the H₂SO₄ and HNO₃ may react with ammonia (NH₃) to form the corresponding salts, that is ammonium sulphate ((NH₄)₂SO₄) and ammonium nitrate (NH₄NO₃). Moreover, there may be many other chemical pathways through which SO₂ and NOₓ in the purge air or atmosphere of the exposure tool can be oxidized into sulphates and nitrates, including homogeneous processes that take place in the gas phase and in liquid droplets or heterogeneous processes that take place on the surfaces of particles or droplets.

In addition to contaminants deposited on sensitive surfaces, volatile molecular contaminants may also exist within the exposure ambient, thereby causing a variation in the intensity of the radiation flux reaching the substrate plane by scattering of radiation particles interacting with the gas phase of the atmosphere. Based on the finding that contaminants, even in minute traces, within the environment or atmosphere of an exposure tool may significantly affect the overall performance of the tool, especially when short exposure wavelengths are involved, systems and methods are provided to detect airborne contaminants and/or contaminants deposited on optical surfaces by means of detection techniques of superior sensitivity and to adapt the operation mode of the exposure tool on the basis of measurement results provided by these detection techniques. Moreover, in other methods, the operational mode of exposure tools may be established to take into consideration the existence of contaminants within the exposure tool atmosphere without actually monitoring the exposure tool atmosphere during most of the operating period or substantially without monitoring the atmosphere at all. To this end, previously gathered measurement results with respect to the presence of contaminants may be used to operate one or more exposure tools in accordance with an established operational mode that is designed to significantly reduce any adverse impacts on the tool performance.

For the detection and/or monitoring of contaminants within the tool atmosphere, highly sensitive and well-known detection techniques may be used, such as absorption spectroscopic techniques, including infrared (IR) spectroscopy, Raman spectroscopy and ultraviolet-visible spectroscopy, chromatographic techniques such as ion chromatography (IC), and spectrometric techniques such as gas chromatography/mass spectrometry (GC-MS), solid phase micro extraction gas chromatography, mass spectrometry with chemical ionization (SPME GC-CIMS), and the like. These detection techniques may be used to identify one or more of specified contaminants and may also allow quantifying one or more contaminants even if being present in minute trace amounts. Moreover, in some embodiments, one or more of these detection techniques such as the UV-visible spectroscopy may be used to directly monitor the influence of the exposure atmosphere on a sensitive surface within the exposure tool, by providing a sample surface, such as a dedicated sample substrate, a portion of a surface of an optical component, and the like, within the exposure chamber. At least some of the detection techniques identified above are known to provide the ability to detect gas and vapor concentrations and/or deposited contaminants with a high signal-to-noise ratio in a wide dynamic range and also for good cross-sensitivity. For instance, airborne contaminants may efficiently be detected by SPME GC-CIMS, GC-MS and IC spectrometers, whereas contaminants deposited on surfaces may be detected by IC, IR, UV-visible and Raman spectrometers. In particular, the SPME GC-CIMS and GC-MS spectrometers offer excellent sensitivity, very low detection limit, excellent identification and speciation capabilities. Hence, by using these detection techniques in combination with exposure tools, the operational mode of the exposure tool may be established on the basis of information received from the detection systems, thereby providing the potential for significantly reducing contaminant-induced performance degradation.

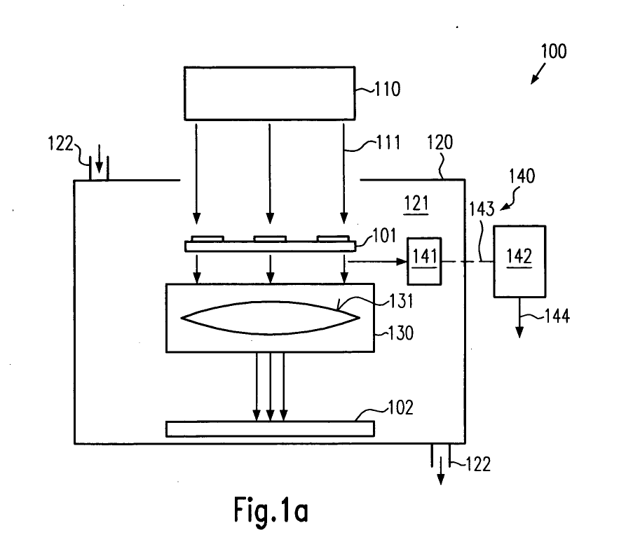

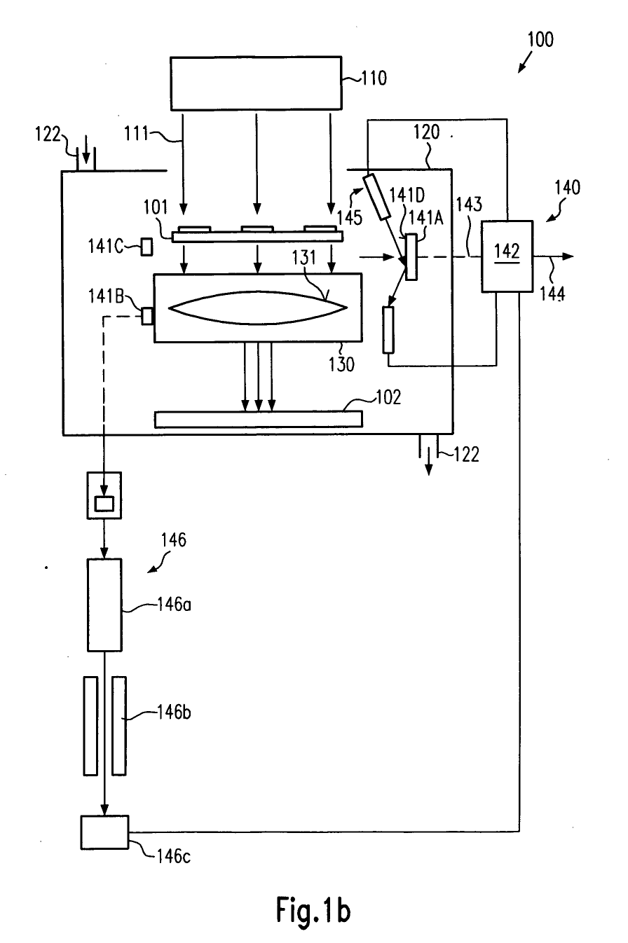

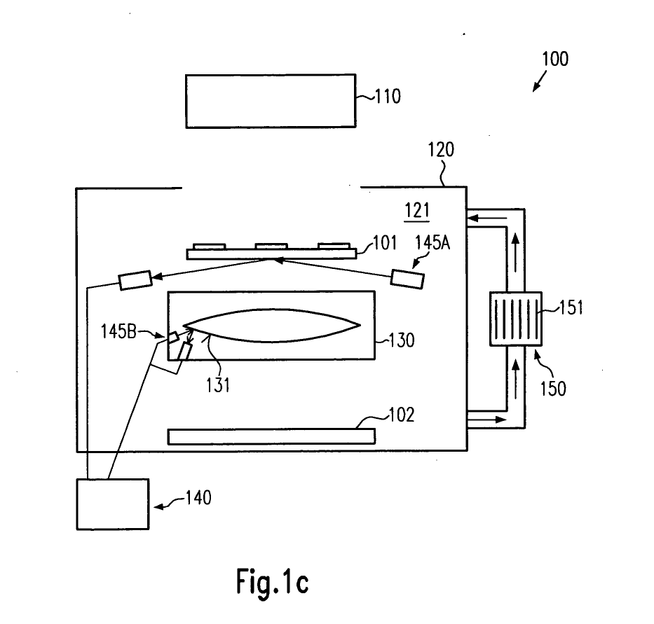

With reference to FIGS. 1a-1c, further illustrative embodiments of the present invention will now be described in more detail. In FIG. 1a, an exposure system 100 comprises a radiation source 110, an exposure chamber 120, an optical system 130 and a chemical detection system 140. The exposure system 100 may represent, in one particular embodiment, a lithography tool operated at a deep UV wavelength of, for instance, 248, 193, 157 or 13.4 nm, which may be used in imaging a pattern formed on a reticle 101 onto a substrate 102 by means of the optical system 130. In other embodiments, the exposure system 100 may represent any other exposure tool used for forming features that may be involved in the fabrication of micromechanical, micro-optical and microelectronic devices. That is, in some embodiments, the exposure system 100 may represent an x-ray exposure tool or an electron beam exposure tool. Consequently, the radiation source 110 may represent any source that is capable of providing a short wavelength radiation 111 within a specified required wavelength range and with a specified required exposure dose. For example, the radiation source 110 may comprise an excimer laser device operating at moderately high pulse rates at a wavelength of approximately 193 nm.

The optical system 130 is adapted to transmit the radiation 111 received from the radiation source 110, possibly through the reticle 101, onto the substrate 102 to form, for instance, a projected, i.e., reduced, image on the substrate 102. For example, for a deep UV exposure radiation 111, the optical system 130 may comprise one or more optical components, such as a lens and the like having one or more optically active surfaces such as refractive or reflective surfaces, which are indicated as 131. For other types of short wavelength radiation, such as x-rays and electron beams, the optical system 130 may comprise corresponding components, such as apertures, quadruple lenses, optical blades, mirrors and the like, to correspondingly direct the radiation 111 to the substrate 102. The optical system 130, the substrate 102 and the reticle 101, if provided, are disposed within the exposure chamber 120, in which prevails a certain environment including a gaseous atmosphere 121, which may communicate with external supply sources, the ambient atmosphere and the like by a corresponding ventilation system indicated as 122. As previously noted, the condition of the atmosphere 121, e.g., the chemical composition of the gaseous components, the excitation state or charge state of one or more of these components, and the like, is substantially determined by the purge gas delivered to the exposure chamber 120 via the ventilation system 122, the materials that are in contact with the atmosphere 121, such as construction materials of the chamber 120, the reticle 101, the optical system 130, the substrate 102, as well as the dose and wavelength of the radiation 111. Consequently, the composition of the atmosphere 121 may depend on the purge gas and any contaminants contained therein, such as the previously identified oxygen, sulphur dioxide, nitrogen oxides, water, and the like, as well as components out-gassing from any surfaces in contact with the atmosphere 121. Furthermore, the interaction of the high energetic photons or electrons of the radiation 111 may also create new contaminants or modify existing contaminants. As a consequence, the status of the atmosphere 121 is defined by a highly complex dynamic gas system, wherein, in particular, the interaction of short wavelength radiation as used in highly advanced lithography tools may result in performance fluctuations caused by gaseous contaminants and even in the form of contaminants deposited on sensitive surfaces, such as the surface 131 or the reticle 101. Due to the fact that the contaminants are significantly influenced by the interaction of the radiation 111 with the atmosphere 121, i.e., with contaminants contained therein, finally resulting in the deposition of solid contaminants, a progressively increasing influence on the tool performance may be observed, which renders a prediction of reliable performance of a conventional advanced exposure tool extremely difficult. Contrary to conventional exposure tools, the chemical detection system 140 provides enhanced predictability and thus controllability of the exposure process based on measurement results regarding the presence of contaminants in the atmosphere 121 and/or contaminants deposited on sensitive surfaces, such as the surface 131. In general, the chemical detection system 140 comprises a sensor element 141 that may be modified by a contact with the atmosphere 121, wherein the sensor element 141 is in communication with a platform 142 via a corresponding interface 143 with variable electrical, optical or chemical impedance to allow the platform 142 to generate an electrical output signal 144 representing a quantitative indication of the information gathered by the sensor element 141 and conveyed via the interface 143.

In one particular embodiment, the sensor element 141 is positioned within the exposure chamber 120 to “experience” substantially the same environmental conditions as one or more sensitive components of the exposure system 100. For example, the sensor element 141 may be positioned in the vicinity of the reticle 101 and/or the optical system 130 to receive a similar amount of radiation dose and dose distribution (over the reticle) of the radiation 111 and a similar gas flow. It should be appreciated that in other embodiments a plurality of sensor elements 141 may be provided within the exposure chamber 120 at various locations to estimate the condition of the atmosphere 121 at different locations. Moreover, different types of sensor elements may be used to be sensitive to gaseous contaminants or contaminants occurring in the form of deposited material. Moreover, the one or more sensor elements 141 may be appropriately adapted to the specified detection technique used for determining the type and quantity of at least one contaminant within the atmosphere 121. Similarly, the interface 143 and the platform 142 are correspondingly adapted to the type of sensor element 141 and detection technique used. Further illustrative embodiments of the detection system 140 using different types of sensor elements 141 will be described with reference to FIGS. 1b and 1c.

During operation of the exposure system 100, the condition of the atmosphere 121 is substantially determined by the purge gas delivered by the ventilation system 122, the materials in contact with the atmosphere 121 and the operational conditions of the exposure system 100, that is, its exposure dose and time, and the like. For example, for a deep UV exposure tool operating at a wavelength of, for example, 193 nm and processing the substrate 102 having a diameter of 300 mm, the time of exposure of the substrate 102 is significantly greater compared to 200 mm substrates, as are presently used for forming high performance devices, such as microprocessors and the like. In combination with the relatively high photon energy of approximately 6.4 electron volts, an increased production of oxidants compared to standard 248 nm, 200 mm exposure tools may occur. By means of the chemical detection system 140, the presence of at least one contaminant, which may significantly affect the exposure process, is quantitatively detectable thereby providing the potential for establishing an operational mode of the system 100 on the basis of the quantitative measurement results. In some embodiments, the sensor element 141 may be configured to be sensitive to at least one precursor responsible for the formation of inorganic salts, which may be formed, for instance, according to the chemical reaction path as previously pointed out. For example, the sensor element 141 may be sensitive to sulphur dioxide, which may be assumed to substantially be introduced into the atmosphere 121 by the ventilating system 122. Thus, upon the detection of this precursor material within the atmosphere 121 in an amount that exceeds a specified threshold, a specified operation protocol may be invoked to take into account an increased concentration of the specified contaminant. In illustrative embodiments, the detection of the at least one contaminant is performed on a substantially continuous basis to provide substantially “real time” quantitative indications of the contaminant concentration. It should be appreciated, however, that depending on the detection technique employed, a varying amount of delay may result with respect to the provision of an actual measurement result compared to the “real” current contaminant concentration. For instance, if a chromatographic technique is used, even if a substantially continuous sample injection is provided, the quantitative indication in the form of the electrical signals 144 may be provided in a time delayed manner with respect to the current status of the atmosphere 121 due to the retention time of the sample ions within the chromatography column.

In other illustrative embodiments, the atmosphere 121 may be monitored temporarily, for instance on a regular basis, to operate the system 100 in coordination with the measurement results temporarily obtained by the chemical detection system 140. For example, one or more sensor elements 141 may be placed at appropriate locations within the exposure chamber 120 and may be exposed to the atmosphere 121 for a specified time period, for instance in the range of several minutes to several hours, and may then be removed or may be replaced by fresh sensor elements, while the sensor elements exposed to the atmosphere 121 may be analyzed remotely. In this case, the interface 143 and the platform 142 may be provided in the form of standard detection tools, i.e., chromatography tools and/or absorption spectrometers, thereby achieving a high degree of flexibility in applying the present invention to conventional exposure tools. Moreover, none or minimal modifications are required in the exposure chamber 120 of conventional exposure tools for receiving the sensor element 141 at appropriate locations.

While in embodiments using a temporary monitoring or detection of contaminants, the definition of a specified critical threshold for one or more specific contaminants may be advantageous in controlling the operation of the system 100, in embodiments using a substantially continuous monitoring, a more flexible and sophisticated control procedure may be established. In particular embodiments, corresponding threshold or threshold ranges for one or more critical contaminants may be determined by establishing a correlation between a value representing the concentration of the contaminant and the condition of one or more critical components of the exposure system 100. That is, sensitive surfaces such as the surface 131, or a surface of the reticle 101, may be examined while the “history” of one or more specified contaminants within the atmosphere 121 has been monitored by the chemical detection system 140. Based on this correlation, the impact of the one or more contaminants, during specified operating conditions, such as specified exposure dose and exposure time and dose intensity variation, on critical components such as lenses and reticles may be estimated and used for determining a corresponding threshold or threshold ranges. For example, the progression of the SO₂ concentration over time may be correlated with a corresponding deposition of ammonium sulphate so that a corresponding value range of SO₂ concentration may be set for the operation of the exposure tool for these specified operating conditions, which may not unduly degrade the tool performance. For example, upon detection of a critical contaminant concentration during the operation of the system 100, which is above a concentration level previously determined as a threshold for safe operation of the exposure tool, an interrupt may be generated during which appropriate clean procedures or maintenance procedures may be performed, such as replacement of inefficient filters, or which may simply be used to “dilute” specific contaminants over time to avoid or at least significantly reduce undue deposition of solid contaminants. For instance, while discontinuing the generation of the radiation 111 by correspondingly controlling the radiation source 110, the production of highly reactive oxidants is discontinued and the concentration of the remaining oxidants may be reduced during the standard ventilation of the exposure chamber 120. Consequently, by appropriately performed operation interrupts or clean and maintenance procedures, which are scheduled on the basis of the quantitative indications provided by the chemical detection system 140, any deleterious effects on the exposure process may significantly be reduced. In particular, when SPME GC-CIMS and TC-MS spectrometers are used in the chemical detection system 140, excellent sensitivity combined with extremely low detection limit is provided and enables the establishment of moderately low threshold values, thereby allowing an operation at a significantly reduced probability for contaminant deposition and thus performance non-uniformities. Hence, appropriate counter measures may be taken at a tool status, at which the impact of contaminants on the system performance and component integrity is still low, even if the measurements are performed in a discontinuous fashion. On the other hand, if one or more of these extremely sensitive techniques is performed on a substantially continuous basis, a more flexible response in controlling the system 100 in response to the measurement results provided by the chemical detection system 140 may be achieved. For example, the scheduling of any interrupts or clean and maintenance procedures may be performed in such a way that substrate handling, throughput, tool availability and other process constraints may also be taken into account, since the previous or “historical” development of the contaminant concentration may allow a certain degree of prediction as to the impact of the further operation of the system 100 with respect to the further development of the contaminant concentration.

In other illustrative embodiments, the exposure system 100 may be operated to form a specified image on one or more first substrates 102 under specified operating conditions, wherein one or more optical components, such as the sensitive surface 131, and/or the reticle 101 and/or the sensor element 141, provided in the form of a sample surface, such as a quartz substrate, is examined by the chemical detection system 140. For example, the deposition of an inorganic salt may be monitored during the processing of the one or more first substrates 102 having formed thereon the specified image obtained during specified operating conditions. Furthermore, the image on the one or more first substrates 102 may be analyzed to establish a correlation between one or more features of the image on the first substrates 102 and the condition of the optical component, such as the surface 131, and/or the reticle 101 and/or the sensor element 141. That is, for instance, a thickness of the inorganic salt may be correlated to one or more characteristics of the image formed on the one or more first substrates 102. Thereafter, the exposure system 100 may be operated to process one or more second substrates, wherein the control of the operation is based on an operational mode established in conformity with the previously obtained correlation. To this end, the image formed on the one or more second substrates may be analyzed with respect to the one or more characteristics to estimate the status of the exposure system 100 on the basis of the previously established correlation, wherein the exposure system 100 may be operated without a chemical detection system 140 during the processing of the one or more second substrates. When the analysis of the one or more characteristics of the images on some of the second substrates indicate, based on the established correlation, a critical exposure tool status, appropriate counter measures, such as an interruption, possibly including any cleaning and/or maintenance procedures may be performed.

The correlation may be established, for example, on the basis of the assessing of test substrates or test dies on product substrates exposed under specified conditions, for instance for a very high exposure dose or exposure time, so that minute changes of the specific image caused by contaminants may be observable on the second substrates, without requiring an actual monitoring of the atmosphere 121 or examination of critical optical components.

In other illustrative embodiments, a mode of operation may be established on the basis of measurement results obtained from the chemical detection system 140 as is described above and also described in the following description with reference to FIGS. 1b and 1c, wherein the corresponding operational mode may then be applied to the operation of the system 100 when not provided with the detection system 140 or for other standard exposure tools having a similar construction as the system 100. For example, based on a specific process recipe for an advanced exposure tool and based on measurement results obtained by the detection system 140 over an extended operation period, an operation mode may be established, including interrupts and possibly clean and maintenance procedures, which may significantly reduce the degradation of critical components and may also significantly enhance process uniformity, without actually requiring the monitoring of the respective chamber atmospheres 121. That is, for a specified process recipe, certain “specifics” of the exposure process that mainly depend on the presence of one or more contaminants may be revealed during the measurement phase. Thereafter, appropriate counter measures in form of a specified operation mode may be established and may preferably be confirmed prior to using the operation mode in actual production situations, wherein the operation mode established provides reduced contaminant induced process variation and/or component degradation. That is, the operation mode established provides a significantly reduced progressive defect rate as is currently observed in conventional techniques.

FIG. 1b schematically shows the exposure system 100 in accordance with further illustrative embodiments of the present invention. The chemical detection system 140 may comprise, in one embodiment, an absorption spectrometer 145 and/or a chromatography apparatus 146, which may advantageously be combined with a mass spectrometer. Moreover, the detection system 140 may comprise a plurality of sensor elements 141a, 141b, 141c which may differ in position within the chamber 120 and type of sensor material. In one particular embodiment, the sensor element 141a associated with the absorption spectrometer 145 may comprise a sample surface 141d that enables an efficient determination of a layer thickness of a contaminant deposited on the sensor element 141a. In one illustrative embodiment, the sensor element 141a having the sample surface 141d is provided in the form of a quartz substrate so that the transmittance and/or reflectivity of the sensor element 141a may be measured by the absorption spectrometer 145 or by any other appropriate optical equipment having a light source and a light detector appropriately oriented with respect to the sensor element 141a. Consequently, the absorption spectrometer 145 may be preferably usable in detecting contaminants deposited on the sensor element 141a, thereby also providing a measure of contamination of critical components such as the surface 131 and/or the reticle 101. The absorption spectrometer 145 may represent one or more of the following spectroscopy techniques: IR, UV-visible and Raman spectroscopy techniques. In other embodiments, the contaminant deposited on the sample surface 141d may be analyzed by ion chromatography. Moreover, it should be appreciated that, as previously explained, the sensor element 141a may be removed for analysis and the absorption spectrometer 145 or an ion chromatography apparatus, may be provided externally to the exposure chamber 120. In embodiments relating to a substantially continuous measurement by means of ion chromatography, an appropriate injection system (not shown) may be attached to the sensor element 141a to enable a substantially continuous injection of a sample into the chromatography column. In particular embodiments, the absorption spectrometer 145 may be provided in or adjacent to the exposure chamber 120 to enable a substantially continuous analysis of the sensor element 141a. It should further be appreciated that the type of absorption spectroscopy depends upon the type of transmission involved in the contaminant of interest, that is, the absorption spectroscopy depends on the frequency range of the electromagnetic radiation absorbed by the contaminant of interest. If the transition occurs between vibrational energy levels of the contaminant of interest, then the radiation is a part of the infrared range and the technique involved is an infrared spectroscopy. Similarly, if the transition involved is related to a reconfiguration of the valence electrons in the molecule, the radiation is a portion of the ultraviolet-visible spectrum and the technique is ultraviolet-visible or electronic absorption spectroscopy. If the absorption is accompanied by a transition between rotational energy levels, the resulting radiation belongs to the microwave portion of the electromagnetic spectrum and the technique is a microwave spectroscopy. In vibrational spectroscopy techniques, that is, infrared and Raman spectroscopy, these both techniques are complementary and may be used in combination, when the detection of both, molecules with a change in dipole moment and a change in polarizability of the molecules, is required during vibrational transitions. Advantageously, the absorption techniques may be used to identify and measure a large variety of materials, compounds, contaminant gases and layers with high sensitivity. Moreover, the absorption techniques may readily enable a substantially continuous detection of contaminants in a “real time” manner.

The chromatography apparatus 146 on the other hand, may represent any appropriate chromatography technique using the principle that molecules with different chemical specificities interact differently with the packing materials of the chromatography column 146a so that different contaminants will elude at different speeds and different retention times from the chromatography column 146a. By coupling the chromatographic column 146a to a mass spectrometer 146b, different components of the contaminant may be introduced from the column 146a to the mass spectrometer 146b, thereby providing an enhanced resolution between the measurement peaks. The mass spectrometer 146b detects the electrical current of ionized molecules reaching a corresponding ion detector 146c. In the mass spectrometer 146b, molecules to be analyzed are ionized by a bombardment with electrons emitted from a hot cathode and accelerated in an electric field at a vacuum with a pressure lower than approximately 10⁻⁴ mm mercury. At this low pressure, the concentration of colliding electrons is much higher than the concentration of detected molecules. Furthermore, the pressure is low enough to eliminate interaction of ions and molecules. Consequently, even in a complex mixed sample, the concentration of each type of ions is proportional to the concentration of the corresponding “parent” molecules and does not depend on the sample composition.

Thus, the chromatography apparatus 146 provides excellent sensitivity for a plurality of contaminants. The sample collection may be accomplished by means of the sensor elements 141b, which may be provided in the form of solid phase micro extraction films positioned at specified locations of interest for a specified time period. Thereafter, the sensor elements 141b, 141c may be connected to the chromatography apparatus 146 having the appropriate column 146a, which is then operated with an appropriate temperature program and carrier gas. For example, an appropriate chromatography column may be a stabilwax column 15 cm×0.25 mm (Restek). An appropriate temperature program may be set at approximately 40° C. for about 0.6 min and ramping the temperature at a rate of approximately 15° C. per min to approximately 250° C. Hereby, helium with a flow rate of approximately 1 ml per min may act as a carrier gas. The ranges of concentration of identified contaminants may be estimated on the basis of the total area of the specific masses of a specific contaminant and an empirical response factor, as is well known in the art. For instance, inorganic sulphur and nitrogen containing contaminants may be derivatized with diazomethane, before being injected into the chromatography apparatus 146.

It should be appreciated that the absorption spectrometer 145 and the chromatography apparatus 146 may be used individually or in combination with the exposure system 100. Moreover, threshold values or ranges and appropriate operational modes upon detection of one or more specified contaminants may be established as described with reference to FIG. 1a above.

FIG. 1c schematically shows the exposure system 100 in accordance with further illustrative embodiments. In the embodiment shown, the chemical detection system 140 may comprise a first optical detection system 145a that is configured to determine the type and quantity of at least one specified contaminant deposited on an optical component, which may present, in the embodiment shown, a portion of the reticle 101. For example, the optical detection system 145a may represent one of the absorption techniques explained above. Hence, the reticle 101 may act as a sensor element for the optical detection system 145a. Alternatively or additionally, the detection system 140 may comprise a second optical detection system 145b that is configured to quantitatively detect at least one specific contaminant deposited on an optical component of the system 130. For example, the sensitive surface 131 may be selected as a sample surface for the second optical detection system 145b, which is appropriately equipped and positioned to enable the analysis of the sensitive surface 131 during the operation of the system 100 and/or during specified periods, when the substrate processing is interrupted. For example, the second optical detection system 145b may be provided with a corresponding drive assembly (not shown) to be moveable into a position at which the individual components of the system 145b do not interfere during the regular operation of the system 100. In other embodiments, the optical system 130 may be designed to allow the detection system 145b access to the surface 131 during the regular operation of the system 100. With respect to any control strategies and operation modes of the exposure system 100 as shown in FIG. 1c, the same criteria apply as previously explained with reference to FIGS. 1a and 1b. Moreover, it should be appreciated that the exposure system 100 shown in FIG. 1c may also be provided with further detection means, such as the chromatography apparatus 146 of FIG. 1b to reliably detect or monitor gaseous contaminants within the atmosphere 121.

In further embodiments, the exposure system 100 may comprise a regeneration system 150 in communication with the chamber atmosphere 121. The regeneration system 150 may be configured to remove or modify one or more specific contaminants. For instance, the regeneration system 150 may comprise catalyst surfaces 151 configured to initiate a chemical reaction to modify or remove one or more gaseous contaminants in the chamber atmosphere 121. For example, upon detection of a critical concentration of one or more specific contaminants within the atmosphere 121, including any contaminants deposited on a sample surface, such as the sensor elements 141a, the reticle 101 or the sensitive surface 131, the exposure system 100 may be switched into an operational mode in which the operation of the regeneration system 150 may not have an adverse effect on the overall operation of the system 100. That is, the operation of the regeneration system 150 may require a corresponding elevated temperature of the catalyst surfaces 151 and/or an increased airflow through the system 150, and the like, which may not be tolerable during the actual processing of the substrate 102. Consequently, when the control strategy of the exposure system 100 commands an interrupt, based on a quantitative indication of the concentration of one or more specified contaminants within the atmosphere 121, the regeneration system 150 may be instructed to operate to efficiently remove or modify the contaminants by, for instance, increasing the air flow and/or heating a catalyst surface 151, and the like. It should be appreciated that the regeneration system 150 may represent any type of system that enables the removal or modification of one or more specific contaminants on a physical or chemical basis wherein, depending on the mechanism used, a continuous or intermittent operation of the system 150 may be performed. It should further be appreciated that the regeneration system 150 may be operated without being directly controlled by the detection system 140, once an appropriate operational mode has been established for the exposure system 100 including the regeneration system 150 on the basis of measurement results obtained as described above.

As a result, the present invention provides a technique that enables the operation of highly advanced exposure tools based on short wavelength radiation sources with increased reliability and uniformity, since the presence of gaseous and/or solid contaminants within an exposure atmosphere is quantitatively determined, at least during specified operating periods. By using highly efficient and sensitive detection techniques, such as chromatography techniques and absorption spectroscopy continuously or intermittently, the adverse effect of contaminants on critical components of the exposure tools as well as on the uniformity characteristics of the exposure process may significantly be reduced. Moreover, the present invention also enables the establishment of enhanced operational modes for sophisticated exposure tools on the basis of sensitive measurement of one or more contaminants within the exposure atmosphere, wherein an exposure tool may be operated, at least over extended periods, without actually monitoring the exposure atmosphere. That is, enhanced strategies may be established on the basis of measurement data to reduce process non-uniformities and/or premature failure of optical components by integrating, at least temporarily, sophisticated and highly sensitive detection techniques for trace contaminants into the lithography process.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An exposure system, comprising:
a radiation source configured to provide radiation of a specified wavelength range and exposure dose range;
an exposure chamber having a chamber atmosphere;
an optical system disposed in said exposure chamber and configured to receive radiation from said radiation source and image said received radiation onto a substrate; and
a detection system configured to quantitatively detect at least one contaminant in said chamber atmosphere.

2. The exposure system of claim 1, wherein said detection system comprises a sample surface disposed in said exposure chamber, said sample surface being exposed to said chamber atmosphere to receive at least one of said contaminant and a compound formed from said at least one contaminant.

3. The exposure system of claim 2, wherein said sample surface comprises a witness sample portion made of substantially the same material as an optical surface of at least one optical component of said optical system.

4. The exposure system of claim 3, wherein said witness sample portion is disposed within said exposure chamber to experience substantially the same chamber atmosphere and receive substantially the same radiation dose and dose distribution as said at least one optical component.

5. The exposure system of claim 2, wherein said sample surface is comprised of a surface portion of at least one optical component of said optical system.

6. The exposure system of claim 5, wherein said detection system comprises an optical detector for scanning said sample surface.

7. The exposure system of claim 6, wherein said optical detector is disposed within said optical system.

8. The exposure system of claim 1, wherein said detection system comprises a detector based on at least one of a chromatography technique and a spectroscopic technique.

9. The exposure system of claim 8, wherein said detector comprises a gas chromatography apparatus in combination with a mass spectrometer.

10. The exposure system of claim 1, further comprising an indication unit operatively coupled to said detection system and configured to provide an indication of a tool status on the basis of a quantitative detection of said at least one contaminant.

11. The exposure system of claim 10, further comprising a control unit operatively coupled to said indication unit to receive said indication, said control unit configured to control operation of said exposure system on the basis of said indication.

12. The exposure system of claim 11, further comprising a regeneration reactor connected to said chamber atmosphere and configured to chemically modify said at least one contaminant.

13. A method, comprising:
operating an exposure tool comprising a radiation source, an exposure chamber and an optical system disposed within said exposure chamber;
monitoring an atmosphere within said exposure chamber to provide a quantitative indication for at least one contaminant in said atmosphere; and
estimating an operational status of said exposure tool on the basis of said quantitative indication.

14. The method of claim 13, wherein monitoring said atmosphere comprises providing a sample surface within said exposure chamber and analyzing material adsorbing to said sample surface.

15. The method of claim 13, wherein monitoring said atmosphere comprises detecting a gaseous contaminant within said atmosphere.

16. The method of claim 13, wherein monitoring said atmosphere comprises temporarily positioning a sensor element within said exposure chamber, removing said sensor element and remotely analyzing a status of said sensor element.

17. The method of claim 14, wherein analyzing said adsorbed material comprises at least one of determining an amount of material deposited on said sample surface and examining an optical behavior of said sample surface.

18. The method of claim 13, further comprising controlling operation of said exposure tool on the basis of said operational tool status.

19. The method of claim 18, wherein controlling operation of said exposure tool comprises interrupting operation of said exposure tool when said quantitative indication exceeds a specified tolerance threshold.

20. The method of claim 19, further comprising performing a specified maintenance procedure when operation is interrupted.

21. The method of claim 13, wherein monitoring said atmosphere comprises determining within said atmosphere an amount of one or more precursors for at least one inorganic salt.

22. The method of claim 13, wherein monitoring said atmosphere comprises using at least one of a chromatography technique and a spectroscopy technique.

23. The method of claim 13, wherein operating said exposure tool comprises operating said exposure tool during a first operating period and operating said exposure tool during a second operating period for processing one or more substrates at least during the second operating period, wherein monitoring said atmosphere is performed during said first operating period, and wherein said second operating period is controlled on the basis of said tool status.

24. A method, comprising:
operating, during a first operating period, an exposure tool comprising a radiation source, an exposure chamber and an optical system disposed within said exposure chamber;
monitoring an atmosphere within said exposure chamber to provide a quantitative indication for at least one contaminant in said atmosphere;
establishing an operational mode for said exposure tool for a second operating period on the basis of said quantitative indication; and
operating said exposure tool in said operational mode during said second operating period.

25. The method of claim 24, wherein monitoring said atmosphere is discontinued during said second operating period.

26. The method of claim 24, further comprising operating a second exposure tool in said operational mode.

27. The method of claim 24, wherein said operational mode comprises at least one interrupt to reduce contaminant concentration in said atmosphere.

28. A method, comprising:
operating an exposure tool comprising a radiation source, an exposure chamber and an optical system disposed within said exposure chamber, operating said exposure tool comprising transferring an image onto one or more first substrates;
determining a quantitative indication of at least one characteristic of said images formed on said one or more first substrates;
determining a condition of a component of said exposure tool that is exposed to an atmosphere within said exposure chamber;
determining a threshold of said quantitative indication based on said quantitative indication and said condition, said threshold representing an invalid tool status;
operating said exposure tool to process one or more second substrates to form said image on said one or more second substrates;
determining said quantitative indication for said one or more second substrates; and
comparing said quantitative indication for said one or more second substrates with said threshold to estimate whether a current tool status is an invalid tool status.

29. The method of claim 28, wherein said component is a part of said optical system.

30. The method of claim 28, wherein said component is a reticle.

31. The method of claim 28, wherein said component comprises a sample surface to adsorb a contaminant thereon.

32. The method of claim 31, wherein determining a condition of said component comprises analyzing material adsorbed by said sample surface by at least one of a chromatography technique and a spectroscopy technique.
